(19) United States
(12) Patent Application Publication
(10) Pub. No.: US 2009/0195919 A1
(43) Pub. Date: Aug. 6, 2009

(54) METHOD OF FABRICATING A SUSPENSION

(75) Inventor: Niraj Mahadev, Tracy, CA (US)

Correspondence Address: KENYON & KENYON LLP, RIVERPARK TOWERS, SUITE 600, 333 W. SAN CARLOS ST., SAN JOSE, CA, 95110, US

(73) Assignee: SAE Magnetics (H.K.) LTD., Shatin (HK)

(21) Appl. No.: 12/024,864

(22) Filed: Feb. 1, 2008

(51) Int. Cl. G11B 5/012; G11B 21/24

(52) U.S. Cl. 360/86; 360/240; 360/245

(57) ABSTRACT

In a method of fabricating a suspension, a suspension has first and second opposing surfaces and includes a flexure, a load beam, a mounting arm, and traces. The flexure is coupled to a proximal end of the load beam, and the mounting arm is coupled to a distal end of the load beam. The traces are coupled to the flexure. A suspension property to be altered is identified. A value of the unaltered suspension property is measured. An altered value of the suspension property is determined. The flexure, the load beam, or the mounting arm of the suspension, or a combination thereof, is coated with at least one layer of at least one film to alter the identified suspension property from the measured value to the predetermined altered value.

### BACKGROUND INFORMATION

The present invention relates to a suspension for use in a magnetic information storage disk drive. In particular, the present invention relates to a method for fabricating a suspension.

FIG. 1 illustrates a conventional hard disk drive design. Hard disk drives are used as the major storage unit in a computer. Hard disk drives 100 operate by storing and retrieving digitized information onto and from a rotating disk 101. The reading and writing of the information onto the disk is performed by a magnetic “head” embedded in a ceramic “slider” which is mounted on a piece of a metal spring, called a suspension. The suspension provides two functions: mechanical support and electrical connection between the “head” and the “pre-amplifier.” Typically, suspensions are predominantly made of stainless steel. Known manufacturing techniques, such as forming, etching, stamping, generally are employed to create the suspension. Together, the slider and the suspension are called a head-gimbal assembly (HGA) or head-suspension assembly (HSA) 102. The suspension consists of many components, including a flexure, a load beam, a mounting arm, traces, and a base plate. Traces provide the electrical connection between the head and the pre-amplifier. Conventionally, traces are predominantly made of copper coated in a polymer matrix. The flexure connects the slider to the load beam, maintaining the relative in-plane alignment between the flexure and the load beam, while permitting the slider to “pitch” and “roll” with respect to the load beam. The load beam typically consists of two rigid portions connected by at least one flexible portion. The flexible portion may be bent elastically to yield a reaction force (known in the art as the “gram load”), which is transmitted through a load dimple to the slider, causing the slider to be pressed against the disk. The gram load is entirely transmitted to and supported by the disk. The area on the flexure where the slider is mounted is called the tongue. The flexure generally is welded to the main load bearing structure with two or more welds.

When the slider is loaded against a stationary disk, it is said to be in a “contact stop” state. Its pitch and roll angles are both zero. If the load beam is held at the same position by a support outside of the slider, and the disk is removed, the slider will no longer be subject to the gram load. Its pitch and roll angles with respect to a reference plane (which may represent the missing disk surface) are called pitch static attitude (PSA) and roll static attitude (RSA), respectively. PSA and RSA together may be called static attitudes. The change of pitch and roll angles includes pitch and roll torques, due to elastic deformation of the flexure.

When the slider is loaded on a rotating disk during normal operations, it does not contact the disk directly, but rides on a cushion or air bearing generated by the rotation of the disk. The air bearing generates both suction and lift forces which balance the gram load. The separation between the slider and the disk surface is called the flying height. It is generally extremely small (typically on the order of 10 nm in state-of-the-art disk drives). The slider pitch and roll angles are also much smaller than the static attitudes. The flying height, pitch, and roll together may be called the “flying attitudes.” The flying attitudes are crucial to the performance and reliability of a disk drive. They may be influenced by factors such as the rotation speed of the disk, the aerodynamic shape of the air-bearing surface (ABS) of the slider, the gram load, the pitch and roll torques applied to the slider by the suspension, and the composition of the suspension.

One disadvantage of conventionally known and used manufacturing techniques for creating stainless steel suspensions is that conventional manufacturing processes leave rough edges and areas which can later become the nucleus for particle drop outs in the disk drive. Both imperfections may lead to thermal asperity events, which in turn, may lead to sensor degradation and improper drive functioning. Moreover, conventionally known and used manufacturing techniques for creating suspensions do not control or compensate for the various forces and torques exerted on the suspension during operation.

Thus, it would be desirable to have an improved method for fabricating a suspension.

### BRIEF DESCRIPTION OF THE DRAWINGS

FIG. 1 illustrates a conventional hard disk drive design.

FIGS. 2a and 2b illustrate one embodiment of a suspension.

FIG. 3 illustrates one embodiment of a suspension.

FIG. 4 illustrates one embodiment of a coated suspension.

FIG. 5 illustrates one embodiment of a coated suspension.

FIGS. 6a-g illustrates one embodiment of a non-metallic film deposited on a flexure of a suspension.

FIG. 7 illustrates one embodiment of a coated suspension.

FIG. 8 illustrates one embodiment of a coated suspension.

FIG. 9 illustrates one embodiment of a coated suspension.

FIG. 10 illustrates in a flowchart one embodiment of a method for fabricating a suspension.

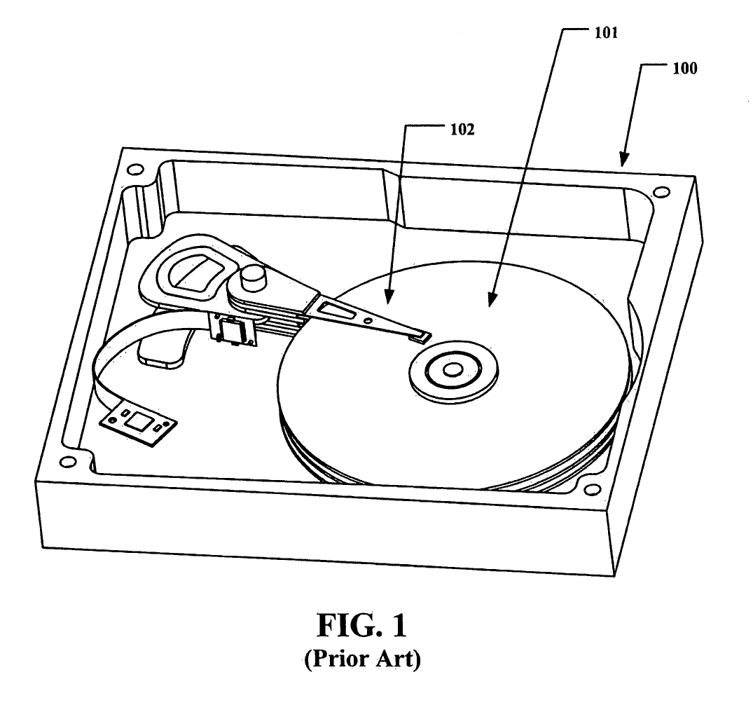

### DETAILED DESCRIPTION

In a method of fabricating a suspension, the suspension may have first and second opposing surfaces and include a flexure, a load beam, a mounting arm, and traces. The flexure may be coupled to a proximal end of the load beam, and the mounting arm may be coupled to a distal end of the load beam. The traces may be coupled to the flexure. A suspension property to be altered may be identified. A value of the unaltered suspension property may be measured. An altered value of the suspension property may be determined. The flexure, the load beam, or the mounting arm of the suspension, or a combination thereof, may be coated with at least one layer of at least one film to alter the suspension property from the measured value to the predetermined altered value.

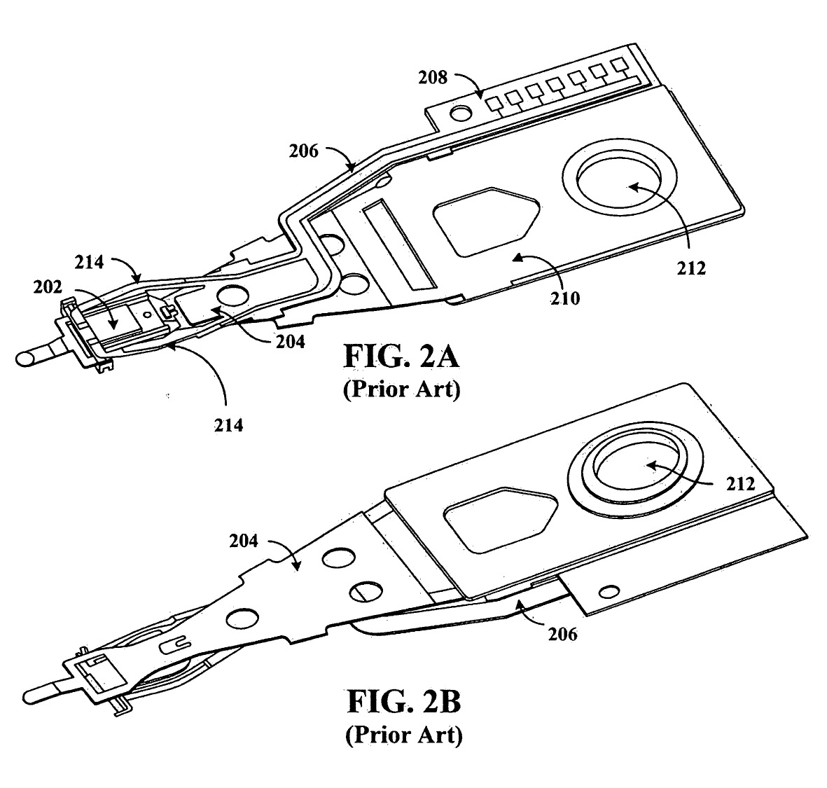

FIGS. 2a and 2b illustrates one embodiment of a head-gimbal assembly. The head-gimbal assembly (HGA) may include a suspension, including a load beam 204, a slider 202 with an air-bearing surface (ABS), and a flexure 206 having flexure legs 214 coupling the slider 202 to the load beam 204. As illustrated in FIGS. 2a and 2b, the suspension may have first and second opposing surfaces. The load beam may include a hinged section which is connected by a base plate 210 to an actuator or mounting arm (not shown). The HGA may be mounted on a pivoting mounting arm at a hole 212 in the suspension. The mounting arm may be coupled to an actuator (not shown) which may move the slider 202 in a plane relative to the surface of a rotating disk in a disk drive system. The hinged section may be bent such that the load beam 204 is angled by E degrees compared to the base plate 210. The load beam 204 may be connected to the slider 202 through the flexure 206 and may also be connected to the slider via a dimple (not shown). The flexure 206 may be flexible and may allow the slider 202 to pitch (i.e., move about its x-axis) and roll (i.e., move about its y-axis) on the dimple. Traces 208 may be coupled to or placed on the flexure 206 to provide electrical connections to the slider 202. The suspension may be made predominantly of stainless steel and may be formed by known manufacturing techniques, such as, for example, forming, etching, and stamping.

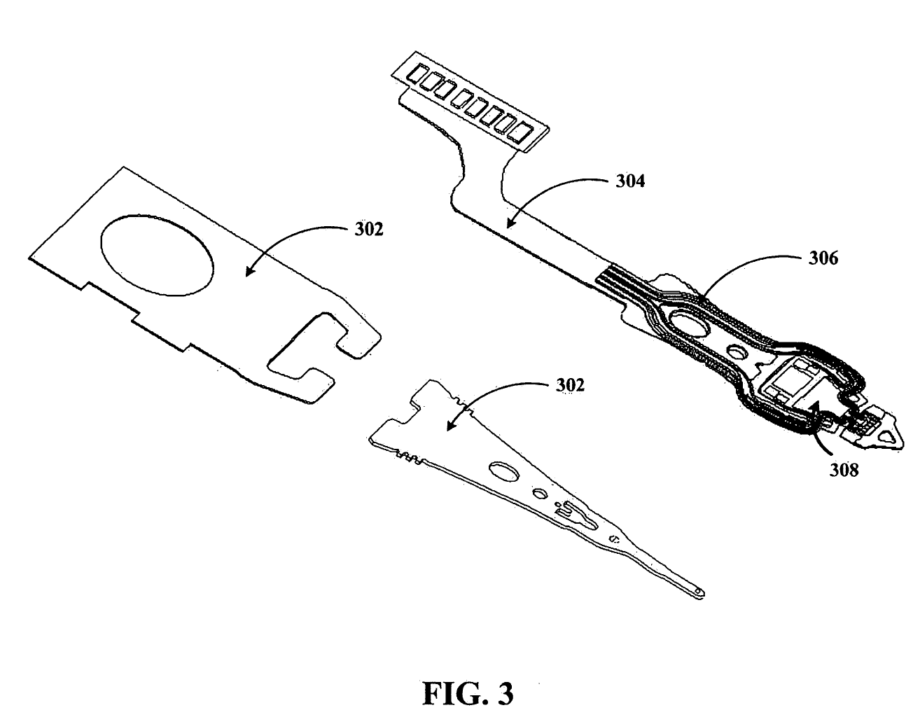

FIG. 3 illustrates one embodiment of a suspension. FIG. 3 illustrates an exploded view of a HGA, showing how the various HGA components are overlaid or coupled to each other. The HGA may include a loadbeam 302, a flexure 304, and traces 306 coupled to the flexure. The area of the flexure where a slider is connected or coupled is called a tongue 308. The suspension may be made of stainless steel using known manufacturing techniques.

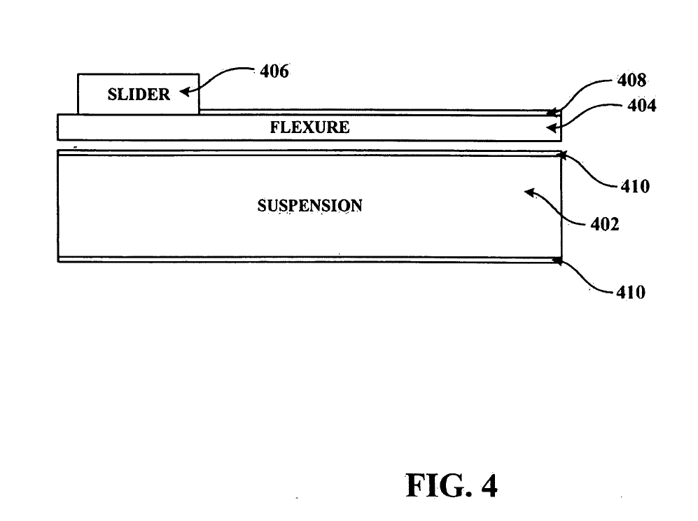

FIG. 4 illustrates one embodiment of a coated suspension. One or both of the opposing surfaces of the suspension may be coated with one or more films. Alternatively, one or both surfaces of select components (e.g., the load beam, the flexure) of the HGA may be coated with the films. Each coating may affect the properties of the suspension during hard drive read or write operations. In one embodiment, the suspension 402 or other components of the HGA, such as the flexure 404 or the traces 408, may be coated with one or more metallic films 410. Examples of metallic films may include silicon-based films, such as SiO₂, SiC, Si₃N₄ and Si. The properties of the suspension may be altered by the applied film, and the degree of alteration may depend on the particular film applied. For example, if a compressive stressed film is applied to the suspension, the stiffness and pitch static angle of the suspension may change. In one embodiment, shape memory alloys, such as NiTi or copper-based (e.g., copper-zinc-aluminum-nickel, copper-aluminum-nickel) alloys, may be deposited on the suspension or other components of the HGA instead of metallic films. Use of shape memory alloys may enable a supplier's original tolerance of a head-gimbal assembly (HGA) or head-suspension assembly (HSA) to be maintained after manufacture of the HGA or HSA by heating the suspension to a temperature equal to the shape memory alloy's transformation temperature. At this temperature, the crystallographic structure of the shape memory alloy may change, thereby enabling the original tolerances of the HGA or HSA to be maintained if the tolerances have changed since manufacture of the HGA or HSA.

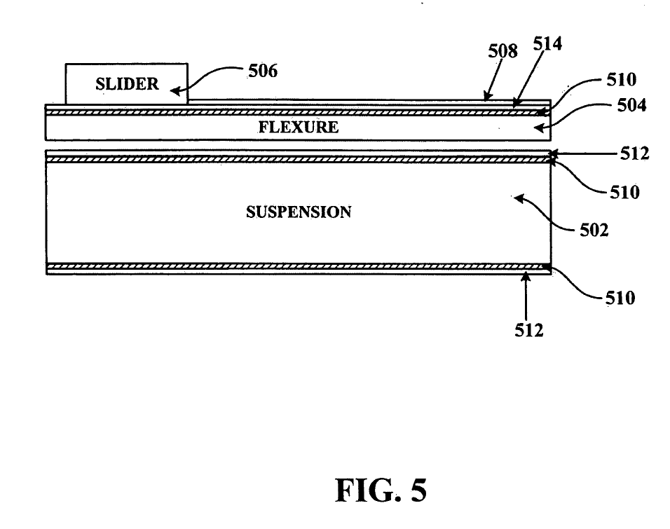

FIG. 5 illustrates one embodiment of a coated suspension. In one embodiment, the suspension 502 or individual components of the HGA, such as the flexure 504 or the traces 508, may be coated with one or more non-metallic films 512, 514, including diamond-like carbon (DLC) films and any of a number of adhesive films 510, such as polyimide and epoxy resins or silicon-based films. Prior to the deposition of a non-metallic film, an appropriate adhesive 510 may be deposited on the surface of the suspension or other component(s) of the HGA. The adhesive underlayer film may alter suspension properties, such as the coefficient of thermal expansion, adhesiveness, and the compressive nature of stress. However, as the adhesive layer may be a thinner layer than the non-metallic film to be overlaid on the adhesive layer, the effect of the adhesive layer may be small. In one embodiment, both opposing surfaces of the suspension 502 may be coated with an adhesive film 510 and a non-metallic film 512. Similarly, a first opposing surface of the flexure 504 may be coated with an adhesive film 510 and a non-metallic film 514. Coating or depositing a surface or surfaces of the suspension or other components of the HGA with a non-metallic film may alter the behavioral properties of the suspension during a read or write operation. For instance, for a conventional HGA, the pitch static attitude (PSA) angle response of the HGA may change or vary due to temperature variations in an operating environment. By coating parts or all of the suspension 502 with a non-metallic film (and the appropriate adhesive layer), changes in the PSA angle response and the flying height of the slider 506 due to temperature variations may be dynamically controlled or compensated for. Generally, the non-metallic films deposited on parts or all of the surfaces of the components of a suspension or the entire suspension with a non-metallic film may compensate for the effects of coefficient of thermal expansion (CTE) mismatches caused by temperature variations as well as for the effects of stress on the suspension.

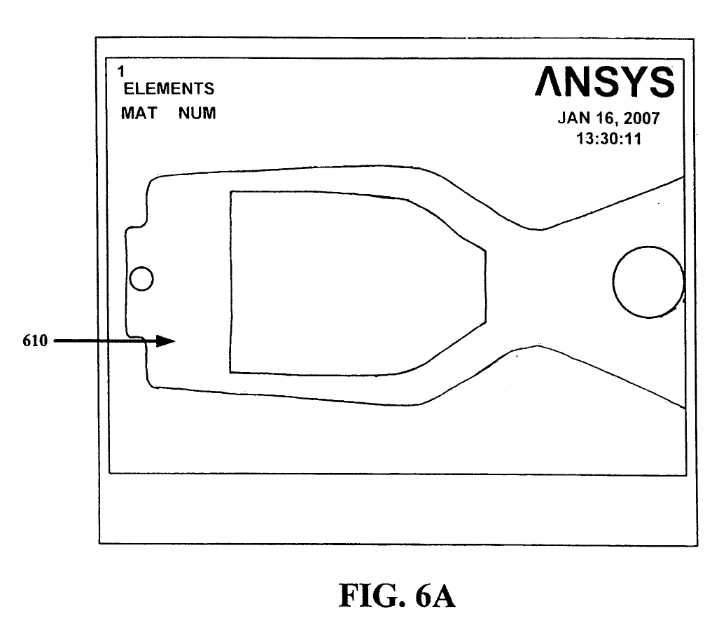

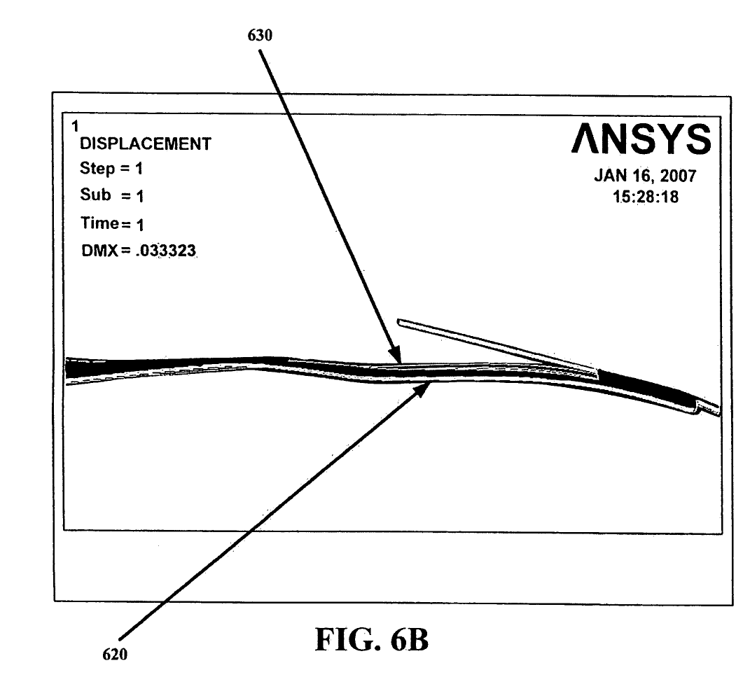

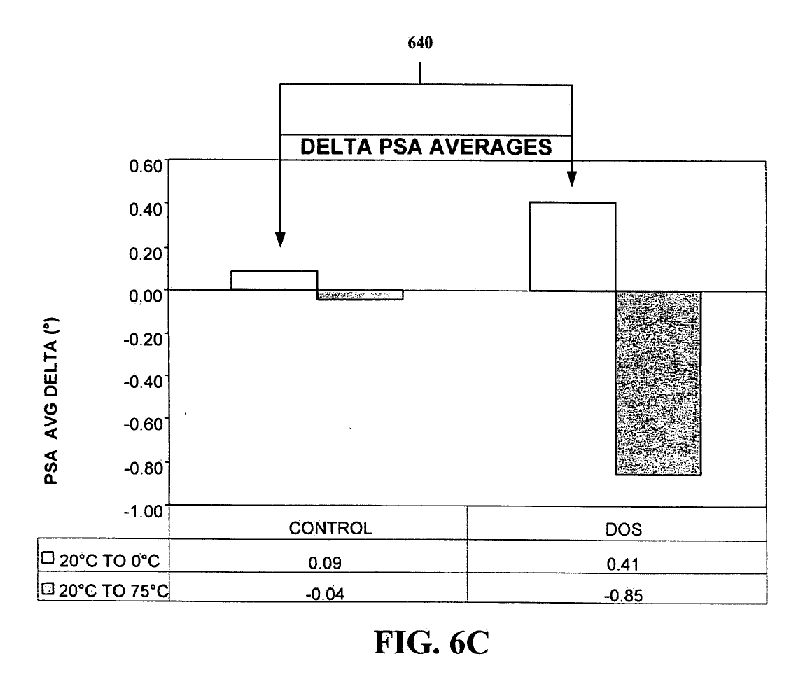

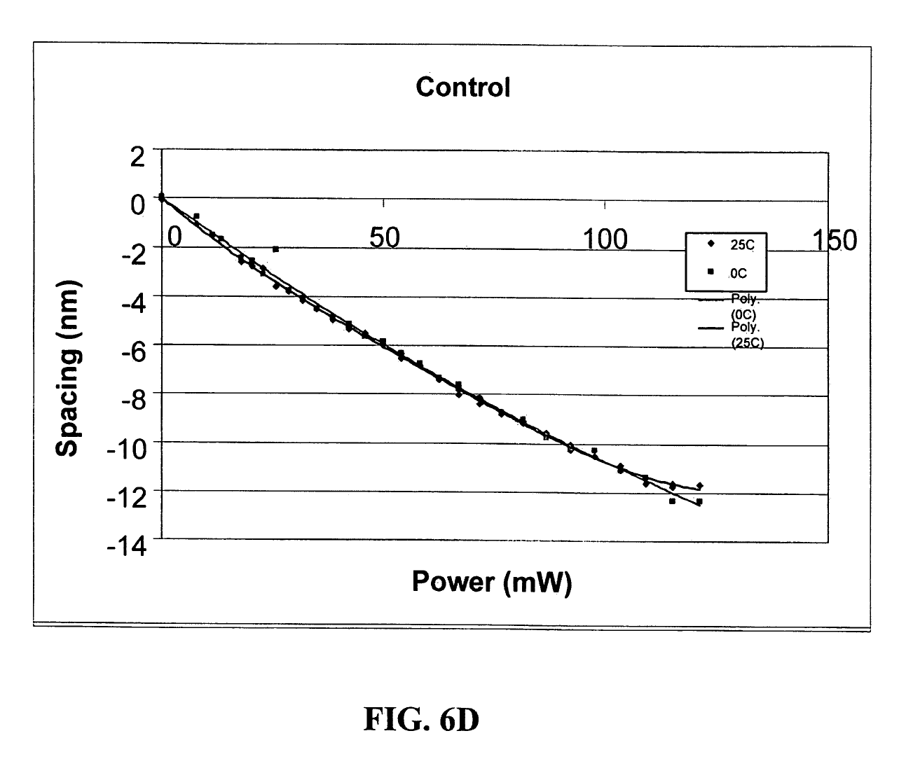

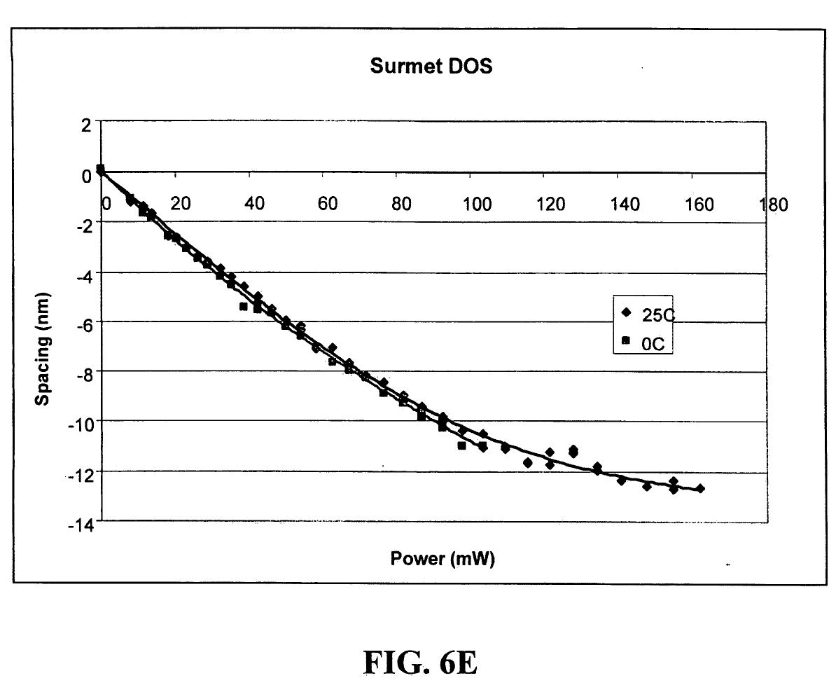

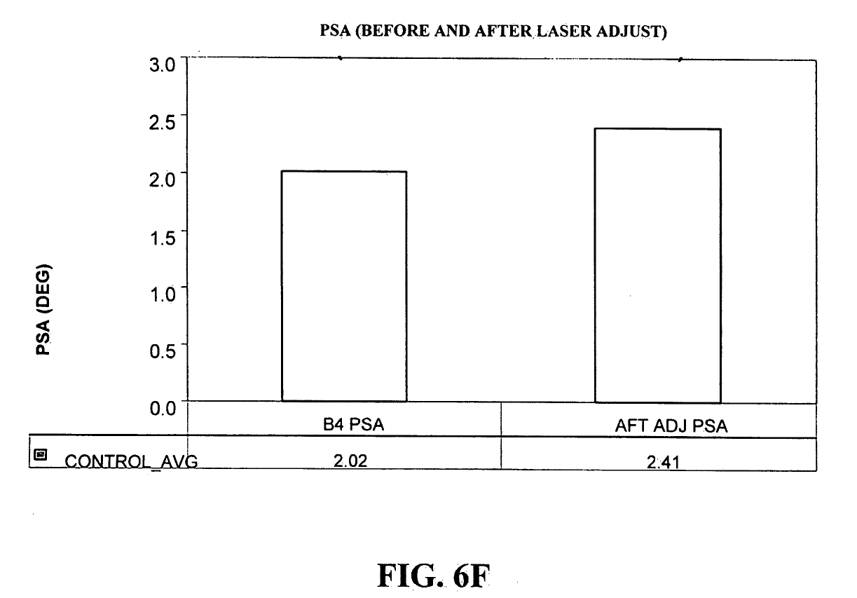

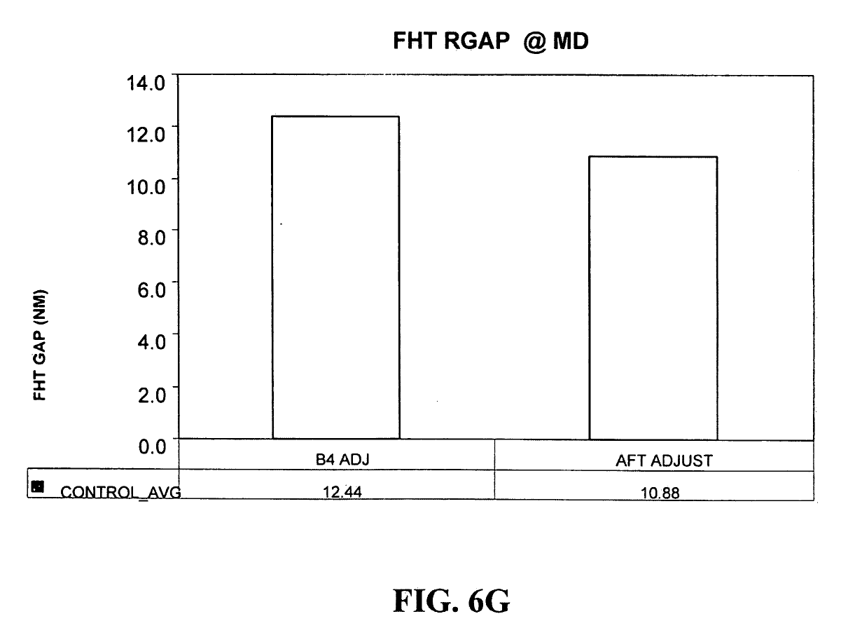

FIGS. 6a-g illustrates one embodiment of a non-metallic film deposited on a flexure of a suspension. In the embodiment, a layer of DLC film 630 may be deposited on the back side of a flexure 620 of a suspension, as shown in FIGS. 6a and 6b. To provide proper adhesion of the DLC film onto the suspension, a silicon coating first may be deposited onto the portion of the flexure to be coated with the DLC film. In one embodiment, the silicon coating and the DLC film may be deposited on the suspension using Plasma-Enhanced Chemical Vapor Deposition (PECVD) or other known methods of chemical vapor deposition. In one embodiment, a 1 micron DLC film may be deposited on the suspension. The deposition of a 1 micron DLC film may a 0.3° increase in the PSA (shown by element 640) of the flexure from room temperature (i.e., 20° C. to 0° C.), as shown by the chart in FIG. 6c. As shown in FIGS. 6d and 6e, depositing a 1 micron DLC film also may result in a 2 nm dynamic flying height (DFH) touchdown (TD) clearance for a slider. FIG. 6f illustrates the results of an optical flying height test performed on a flexure coated with a 1 micron DLC film. In FIG. 6f, the PSA of the flexure may be increased by approximately 0.4° as a result of the deposition of the DLC film. Correspondingly, FIG. 6g illustrates the result of a 1 micron DLC film deposited on the flexure on the gap flying height of a slider. The gap flying height may be the actual height at which a slider flies over a disk surface. The chart in FIG. 6g shows that a DLC film deposited on a flexure may yield an approximately 1.5 nm reduction in the slider gap flying height.

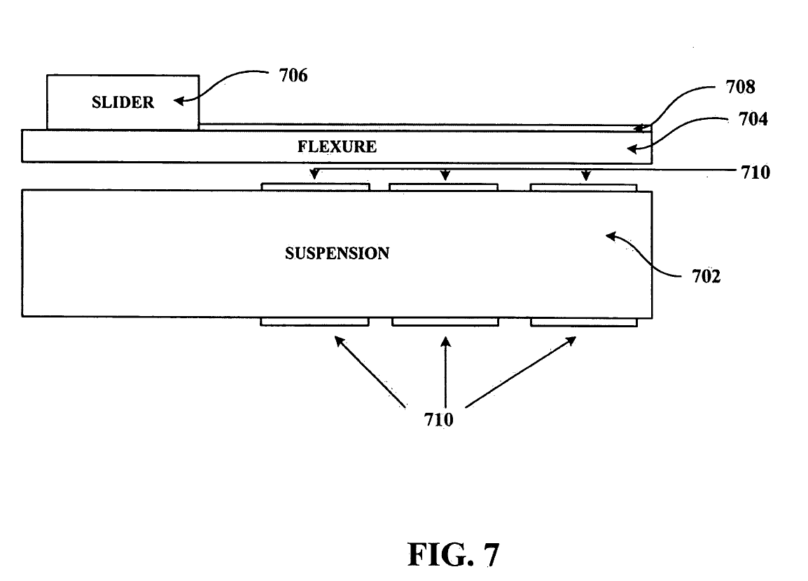

FIG. 7 illustrates one embodiment of a coated suspension. In one embodiment, various components of the HGA may be coated with one or more layers of a high or low modulus of elasticity film. Depositing a film having a high modulus of elasticity on the suspension may improve the rigidity and resonance performance of the suspension by reducing or changing the frequency of the HGA to lessen or avoid resonance. In one embodiment, select areas of the suspension 702 may be coated with a high thermal conductivity film 710. These select areas may serve as heat sinks for the HGA. In this respect, to avoid build up of moisture in the flexure tongue and slider region of the HGA, high thermal conductivity films may be deposited on these select regions of the suspension 702 away from the flexure tongue and slider 706 to attract any moisture away from the tongue and slider region of the HGA.

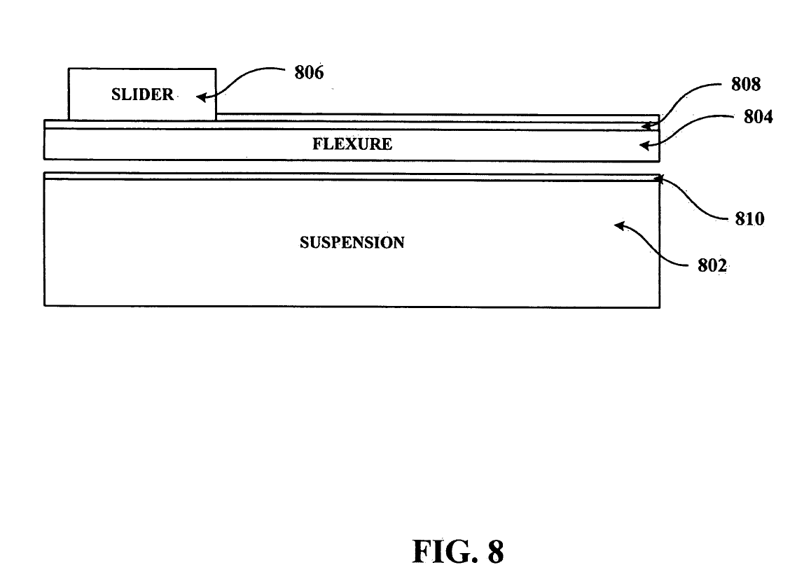

FIG. 8 illustrates one embodiment of a coated suspension. In one embodiment, one surface of the flexure 804 may be coated with a film 808, with the stresses generated by application of the film 808 capable of being exploited to alter the properties of the flexure. Application of a metallic film may alter the PSA of the suspension 802 at various temperatures. Alternatively, application of a non-metallic film may enable the flying height of the slider 806 to be controlled during cold temperatures, when the flying height of the slider 806 generally increases. The non-metallic film may compensate for an increase in flying height at cold temperatures by cause the PSA to change in the +ve direction, thereby reducing or compensating for the increased flying height. In one embodiment, PSA may be altered by coating only the flexure legs (not shown) with a metallic or non-metallic film.

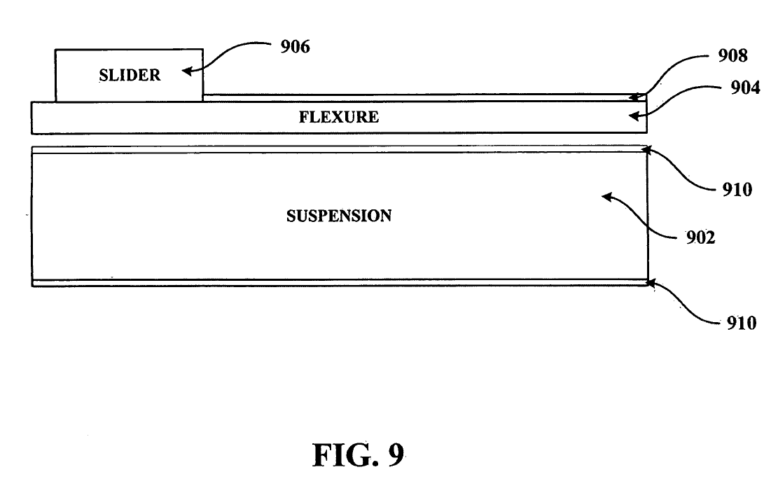

FIG. 9 illustrates one embodiment of a coated suspension. In one embodiment, only the load beam of the suspension 902 may be coated with a film 910, causing a change to the gram load applied to the slider. Depositing a film on both opposing surfaces of the load beam 902 may cause the HGA to bend due to the CTE effects and stresses developed at the interface between the suspension and the deposited film. In one embodiment, only the tongue of the flexure 904 may be coated with a DLC film to reduce the crown change of the slider 906 caused by differing CTEs between the slider body and the HGA. The air bearing surface of a slider 906 may be designed to have a curvature along its length and width. The curvature along the length of the slider ABS is generally known as the crown curvature. Due to temperature variations in a disk drive, the crown curvature may change, thereby affecting the flying height of the slider and the wear and tear on the slider. Coating the flexure tongue with a DLC film may reduce crown change in the slider because the CTE properties of the DLC film may align more closely with the CTE properties of the slider compared to the CTE properties of the slider and the HGA.

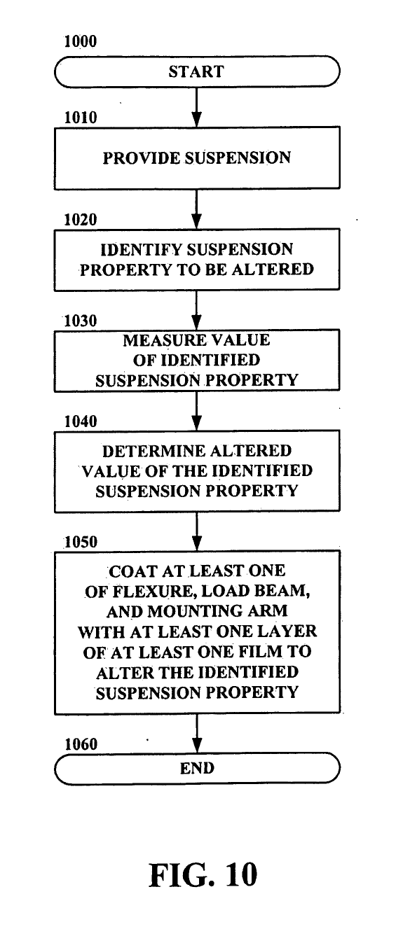

FIG. 10 illustrates in a flowchart one embodiment of a method of fabricating a suspension. In block 1010, a suspension may be fabricated using conventionally known manufacturing techniques, such as forming, etching, and stamping. The suspension may be made of stainless steel. The suspension may include a load beam, a slider with an air-bearing surface (ABS), and a flexure having flexure legs and coupling the slider to the load beam. The suspension may have first and second opposing surfaces. The load beam may be connected at one end to a mounting arm. The mounting arm may be coupled to an actuator (not shown) which may move the slider in a plane relative to the surface of a rotating disk in a disk drive system. The load beam may be connected at the other end to the slider through the flexure. The flexure may be flexible and may allow the slider to pitch (i.e., move about its x-axis) and roll (i.e., move about its y-axis) on the dimple. Traces may be coupled to or placed on the flexure to provide electrical connections to the slider. In block 1020, a property of the suspension to be altered may be identified. Examples of suspension properties capable of being altered or adjusted include but are not limited to slider pitch static attitude, the gram load of the load beam, slider crown curvature, slider flying height, the resonant frequency of the HGA, heat dissipation and moisture accumulation, stresses imposed on the suspension during slider operation, or a combination of these properties.

In block 1030, a value of the identified suspension property is measured. Measurement of the suspension property value may enable a determination of how much alteration of the property is required. In block 1040, an altered value of the identified suspension property is determined. The determination of the altered value may be dependent on the measured unaltered value of the suspension property. The altered value may reflect a change in the suspension property that affects the operation of the suspension or a component of the suspension.

In block 1050, to alter the determined suspension property, one or more components and one or more surfaces of the components of the suspension may be coated by at least one layer of at least one film. Each film or layers of different films applied may alter a property of the suspension. In one embodiment, the film or layers of films may change the suspension property from the measured value to the predetermined altered value. For example, a metallic film, such as a silicon-based film, may strengthen a suspension and alter the stiffness of the suspension. A non-metallic film, bonded to an appropriate underlayer adhesive, may alter the pitch static attitude angle response of a slider to variations in temperature. Application of the non-metallic film, such as a DLC film, also may help compensate for variations in slider flying height caused by temperature variations. A non-metallic film applied solely to the tongue of the flexure may reduce the crown sensitivity of the slider, thereby altering the slider flying height. Coating select surfaces or portions of a surface with a film may alter a suspension property. For example, deposition of a film on one surface of a flexure may alter the stresses exerted on the flexure and change the PSA and flying height of the slider. Coating a load beam with a film may cause the gram load of the load beam to change. Coating only the flexure tongue may reduce the crown change of the slider by better aligning the CTE between the slider body and the film compared to the slider body and the suspension. Application of a high thermal conductivity film to select portions of the suspension may result in the creation of heat sink regions on the suspension. The heat sink regions may draw moisture away from the slider during slider operation. The foregoing examples are merely exemplary and one of ordinary skill in the art should recognize that various films or combinations of films may be deposited on one or more components or surfaces of components of a suspension to alter or manipulate properties of the suspension. The process ends in block 1060.

Embodiments of the invention described above may improve the structure and performance of a suspension. These embodiments are exemplary embodiments, and those skilled in the art will recognize that different aspects of the suspension structure and performance may be improved depending on the choice of film or films and the choice of suspension component on which the film is deposited. Further, those skilled in the art will recognize that additional films or combinations of films may be applied to the various suspension components or surfaces of suspension components to alter one or more suspension properties.

Therefore, the foregoing is illustrative only of the principles of the invention. Further, those skilled in the art will recognize that numerous modifications and changes are possible, the disclosure of the just-described embodiments does not limit the invention to the exact construction and operation shown, and accordingly, all suitable modifications and equivalents fall within the scope of the invention.

What is claimed is:

1. A method of fabricating a suspension, the method comprising:
providing a suspension having a first and a second opposing surfaces, the suspension comprising a flexure, a load beam, a mounting arm, and traces, wherein the flexure is coupled to a proximal end of the load beam, wherein the mounting arm is coupled to a distal end of the load beam, and wherein the traces are coupled to the flexure;
identifying a suspension property to alter;
measuring a value of the identified suspension property;
determining an altered value of the identified suspension property; and
responsive to said determining, coating at least one of the flexure, the load beam, and the mounting arm of the suspension with at least one layer of at least one film to alter the identified suspension property from the measured value to the predetermined altered value.

2. The method of claim 1, wherein the identified suspension property is slider pitch static attitude (PSA) and said coating comprises depositing the at least one film on a first opposing surface of the flexure.

3. The method of claim 1, wherein the identified suspension property is a gram load of the load beam and said coating comprises depositing the at least one film on both opposing surfaces of the load beam.

4. The method of claim 1, wherein the identified suspension properties are slider PSA and flying height and said coating comprises depositing an adhesive layer on the suspension and a non-metallic film on the adhesive layer.

5. The method of claim 1, wherein the identified property is slider crown control and said coating comprises depositing the at least one film on a first opposing surface of a tongue of the flexure, wherein a slider is attached to the first opposing surface.

6. The method of claim 1, wherein the identified suspension property is moisture accumulation near a slider during slider operation and said coating comprises depositing select portions of the suspension with a high thermal conductivity film, wherein the select portions are located distally from the slider.

7. The method of claim 1, wherein the at least one film is selected from the group consisting of a metallic film, a non-metallic film, a ceramic film, a polymer film, a magnetic film, a non-magnetic film, a high modulus film, a low modulus film, a high coefficient of thermal expansion (CTE) film, and a low CTE film.

8. The method of claim 7, wherein the metallic film is a silicon-based film or a shape memory alloy film.

9. The method of claim 7, wherein if the at least one film is the non-metallic film, said coating comprises first coating the at least one of the flexure, the load beam, and the mounting arm of the suspension with an adhesive film prior to the non-metallic film.

10. A head gimbal assembly, comprising:
a slider with a magnetic head having a set of read elements to read data and a set of write elements to write data, said slider having an air-bearing surface and a non-air-bearing surface opposing said air-bearing surface; and
a suspension having a first and a second opposing surfaces, the suspension to support said slider and maintain a spacing between said slider and a magnetic data storage medium, said suspension comprising:
a load beam;
a flexure coupled to a proximal end of said load beam, said flexure having a tongue to which said slider is attached;
a mounting arm coupled to a distal end of said load beam; and
traces coupled to said flexure,
wherein at least one of said load beam, said flexure, and said mounting arm are coated with at least one layer of at least one film to change a property of said suspension.

11. The head gimbal assembly of claim 10, wherein a first opposing surface of said flexure is coated with said at least one film to change slider pitch static attitude (PSA).

12. The head gimbal assembly of claim 10, wherein both opposing surfaces of said load beam are coated with said at least one film to change a gram load of said load beam.

13. The head gimbal assembly of claim 10, wherein said suspension is coated with an adhesive layer and a non-metallic film is deposited on said adhesive layer to change slider PSA and flying height.

14. The head gimbal assembly of claim 10, wherein a first opposing surface of said tongue is coated with said at least one film to change slider crown control, wherein said slider is attached to said first opposing surface.

15. The head gimbal assembly of claim 10, wherein the first opposing surface of said suspension is coated selectively with a high thermal conductivity film to reduce moisture near said slider, the first opposing surface selective coatings located distally from said slider.

16. The head gimbal assembly of claim 10, wherein said at least one film is selected from the group consisting of a metallic film, a non-metallic film, a ceramic film, a polymer film, a magnetic film, a non-magnetic film, a high modulus film, a low modulus film, a high coefficient of thermal expansion (CTE) film, and a low CTE film.

17. The head gimbal assembly of claim 16, wherein the metallic film is a silicon-based film or a shape memory alloy film.

18. The head gimbal assembly of claim 16, wherein if said at least one film is the non-metallic film, said at least one of said flexure, said load beam, and said mounting arm are coated with an adhesive film prior to the non-metallic film.

19. A disk drive, comprising:
a slider with a read/write head having a set of read elements to read data and a set of write elements to write data, said slider having an air-bearing surface and a non-air-bearing surface opposite to said air-bearing surface;
a magnetic data storage medium to store data;
a suspension to support the slider and maintain a spacing between said slider and said magnetic data storage medium, said suspension comprising:
a load beam comprising a flexible portion having a distal and a proximal ends, a first rigid portion coupled to the proximal end, and a second rigid portion coupled to the distal end;
a flexure coupled to the first rigid portion of said load beam, said flexure having a tongue to which said slider is attached;
a mounting arm coupled to the second rigid portion of said load beam; and
traces coupled to said flexure,
wherein at least one of said load beam, said flexure, and said mounting arm are coated with at least one layer of at least one film to change a property of said suspension.

20. The disk drive of claim 19, wherein a first opposing surface of said flexure is coated with said at least one film to change slider pitch static attitude (PSA).

21. The disk drive of claim 19, wherein both opposing surfaces of said loam beam are coated with said at least one film to change a gram load of said load beam.

22. The disk drive of claim 19, wherein said suspension is coated with an adhesive layer, and a non-metallic film is deposited on said adhesive layer to change slider PSA and flying height.

23. The disk drive of claim 19, wherein a first opposing surface of said tongue is coated with said at least one film to change slider crown control, wherein said slider is attached to said first opposing tongue surface.

24. The disk drive of claim 19, wherein a first opposing surface of said suspension is coated selectively with a high thermal conductivity film to reduce moisture near said slider, the first opposing surface selective coatings located distally from said slider.

25. The disk drive of claim 19, wherein said at least one film is selected from the group consisting of a metallic film, a non-metallic film, a ceramic film, a polymer film, a magnetic film, a non-magnetic film, a high modulus film, a low modulus film, a high coefficient of thermal expansion (CTE) film, and a low CTE film.
